(19) United States
(12) Patent Application Publication
(10) Pub. No.: US 2017/0134989 A1
(43) Pub. Date: May 11, 2017

(54) CHANNEL RESERVATION SUPPORT FOR SINGLE BAND SIMULTANEOUS COMMUNICATIONS

(71) Applicant: QUALCOMM Incorporated, San Diego, CA (US)

(72) Inventors: Olaf Josef Hirsch, Sunnyvale, CA (US); James Simon Cho, Mountain View, CA (US); Ning Zhang, Saratoga, CA (US); Alireza Raissinia, Monte Sereno, CA (US); Youhan Kim, San Jose, CA (US); Kapil Rai, Sunnyvale, CA (US)

(21) Appl. No.: 14/936,087

(22) Filed: Nov. 9, 2015

(51) Int. Cl. H04W 28/26; H04W 74/08

(52) U.S. Cl. CPC H04W 28/26; H04W 74/08

(57) ABSTRACT

Methods, systems, and devices are described for supporting simultaneous (e.g., overlapping) data communications by a wireless communication device. More specifically, the described features generally relate to supporting SBS communications by providing mechanisms to help mitigate interference and/or coordinate medium access. One mechanism involves aligning the data communications to mitigate interference. Another mechanism involves using channel reservation signal (e.g., a clear-to-send-to-self (CTS2S) signal) to help maintain simultaneous medium access. Yet another mechanism involves setting a second backoff period for a second channel based at least in part on a first backoff period for a first channel in wireless devices.

### BACKGROUND

Field of the Disclosure

The present disclosure, for example, relates to wireless communication systems, and more particularly to mechanisms that support single band simultaneous communications.

Description of Related Art

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with one or more stations (STAs) or mobile devices. The AP may be coupled to a network, such as the Internet, and enable a mobile device to communicate via the network (and/or communicate with other devices coupled to the access point).

Expanding use of WLANs has generated increasing demand for bandwidth. Advancements such as single band simultaneous (SBS) communications can help meet such demand. However, the use of SBS communications presents various challenges. For example, SBS communications can suffer from relatively high collocation interference. Therefore, mechanisms that support SBS communications are needed.

### SUMMARY

The described features generally relate to one or more improved systems, methods, and/or apparatuses for supporting simultaneous (e.g., overlapping) data communications by a wireless communication device. More specifically, the described features generally relate to supporting SBS communications by providing mechanisms to help mitigate interference and/or coordinate medium access. One mechanism involves aligning the data communications to mitigate interference. Another mechanism involves using a channel reservation signal to help maintain simultaneous medium access. Yet another mechanism involves setting a second backoff period for a second channel based at least in part on a first backoff period for a first channel.

A method for wireless communication is described. The method includes: performing a first contention-based access procedure for a first channel; performing a second contention-based access procedure for a second channel based at least in part on the first contention-based access procedure performed for the first channel; transmitting a first data communication on the first channel based at least in part on the first contention-based access procedure performed for the first channel; and, transmitting a channel reservation signal on the second channel at a beginning of the first data communication on the first channel based at least in part on the second contention-based access procedure performed for the second channel.

The channel reservation signal establishes a network allocation vector (NAV) for the second channel. In some cases, the channel reservation signal is a clear-to-send-to-self (CTS2S) signal.

The method can include setting the NAV based at least in part on at least one operation to be performed in preparation for transmitting a second data communication on the second channel.

The method can include transmitting a second data communication on the second channel during the transmission of the first data communication on the first channel. In some cases, transmitting the second data communication involves ending the second data communication at substantially the same time as the first data communication ends. In some cases, transmitting the first data communication and transmitting the second data communication involve a single band simultaneous (SBS) operation using the first and second channels.

The method can include monitoring the second channel for a backoff period prior to transmitting the first data communication on the first channel as part of performing the second contention-based access procedure. The method also can include performing transmission of the channel reservation signal on the second channel only if the second channel is clear during the backoff period.

The method further can include determining the backoff period for the second channel based at least in part on a different backoff period for the first channel. The method also can include performing transmission of the first data communication on the first channel and transmission of the channel reservation signal on the second channel only if both the first channel is clear during the different backoff period for the first channel and the second channel is clear during the backoff period for the second channel.

The backoff period for the second channel can be determined to be shorter than the different backoff period for the first channel and to end at substantially the same time as the different backoff period.

The method can include monitoring the first channel for the different backoff period as part of performing the first contention-based access procedure. The method also can include performing monitoring of the second channel only for the backoff period.

An apparatus for wireless communication includes: a channel monitor to monitor a first channel as part of a first contention-based access procedure and to monitor a second channel as part of a second contention-based access procedure, the second contention-based access procedure based at least in part on the first contention-based access procedure; a transmitter to transmit a first data communication on the first channel based at least in part on a result of monitoring the first channel and to transmit a channel reservation signal on the second channel at a beginning of the first data communication on the first channel based at least in part on a result of monitoring the second channel. The apparatus can implement the method described above.

Another apparatus for wireless communication includes: means for performing a first contention-based access procedure for a first channel; means for performing a second contention-based access procedure for a second channel based at least in part on the first contention-based access procedure performed for the first channel; means for transmitting a first data communication on the first channel based at least in part on the first contention-based access procedure performed for the first channel; and, means for transmitting a channel reservation signal on the second channel at a beginning of the first data communication on the first channel based at least in part on the second contention-based access procedure performed for the second channel. The apparatus can implement the method described above.

A wireless communications device also is described. The device includes a processor and memory communicatively coupled to the processor. The memory includes comprising computer-readable code that, when executed by the processor, causes a device to: perform a first contention-based access procedure for a first channel; perform a second contention-based access procedure for a second channel based at least in part on the first contention-based access procedure performed for the first channel; transmit a first data communication on the first channel based at least in part on the first contention-based access procedure performed for the first channel; and, transmit a channel reservation signal on the second channel at a beginning of the first data communication on the first channel based at least in part on the second contention-based access procedure performed for the second channel. The device can implement the method described above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communication system, in accordance with various aspects of the present disclosure;

FIG. 2 shows a timing diagram, in accordance with various aspects of the present disclosure;

FIG. 3 shows another timing diagram, in accordance with further aspects of the present disclosure;

FIG. 4A shows a block diagram of an example of a device configured for use in wireless communication, in accordance with various aspects of the present disclosure;

FIG. 4B shows a block diagram of another example of a device configured for use in wireless communication, in accordance with various aspects of the present disclosure;

FIG. 5A shows a block diagram of an example of a wireless communication system, in accordance with various aspects of the present disclosure;

FIG. 5B shows a block diagram of another example of a wireless communication system, in accordance with various aspects of the present disclosure; and

FIG. 6 is a flow chart illustrating an example of a method for wireless communication, in accordance with various aspects of the present disclosure.

### DETAILED DESCRIPTION

This description discloses techniques for mitigating interference at a wireless device by aligning single bandwidth simultaneous (SBS) transmissions to begin at substantially the same time and end at substantially the same time. This approach reduces interference that can otherwise occur due to the collocation of the coexisting transceiver(s) (or separate transmitter(s) and receiver(s)) at a wireless communication device.

During channel contention, the device sets a first backoff period (e.g., a random backoff) for a first channel and sets a second different backoff period (e.g., a point coordination function interframe space (PIFS)) for a second channel. The second backoff period is shorter than the first backoff period and ends at substantially the same time as the first backoff period is to end. Such an approach helps ensure proper sensing of the channels and allows the second channel to be monitored only for the shorter second backoff period.

At a start of a first data communication on the first channel, a channel reservation signal (e.g., a clear-to-send-to-self (CTS2S) signal) is transmitted on the second channel. The channel reservation signal ensures that access to the second channel is maintained (e.g., reserved). For example, the channel reservation signal can set a network allocation vector (NAV) that is long enough for the device to perform frame aggregation or other preparatory operations for the second communication.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

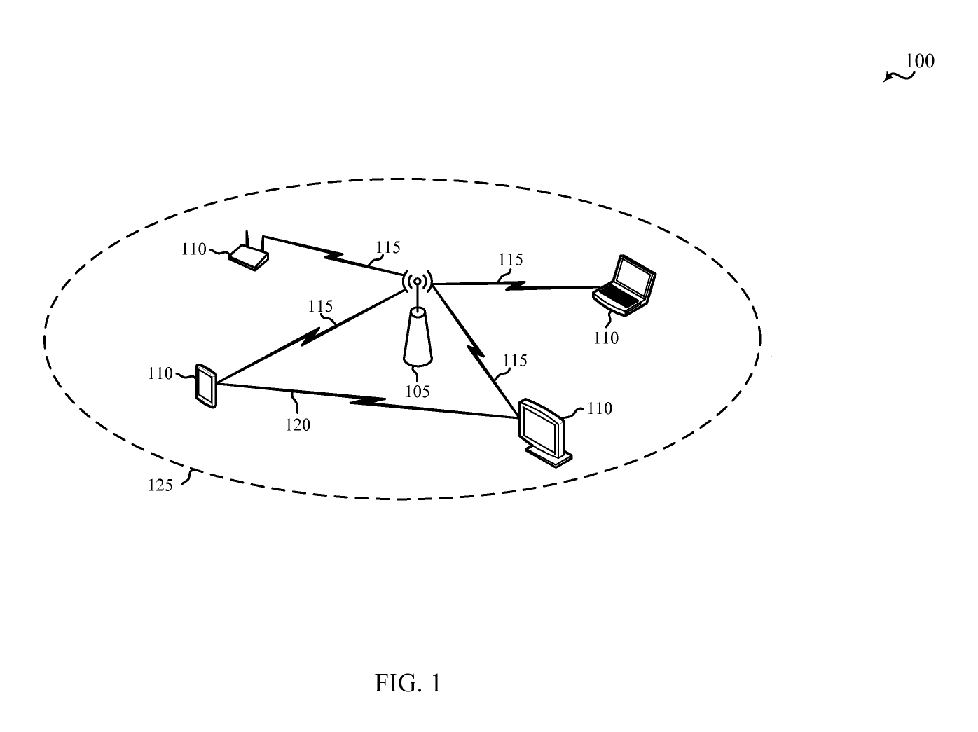

Referring first to FIG. 1, a block diagram illustrates an example of a wireless local area network (WLAN) 100 in accordance with various aspects of the present disclosure. The WLAN 100 includes an access point (AP) 105 and wireless stations (STAs) 110. The STAs 110 can be mobile handsets, tablet computers, personal digital assistants (PDAs), other handheld devices, netbooks, notebook computers, tablet computers, laptops, desktop computers, display devices (e.g., TVs, computer monitors, etc.), printers, etc. While only one AP 105 is illustrated, the WLAN 100 can alternatively have multiple APs 105. STAs 110, can also be referred to as a mobile stations (MS), mobile devices, access terminals (ATs), user equipment (UEs), subscriber stations (SSs), or subscriber units. The STAs 110 associate and communicate with the AP 105 via a communication link 115. Each AP 105 has a coverage area 125 such that STAs 110 within that area are within range of the AP 105. The STAs 110 are dispersed throughout the coverage area 125. Each STA 110 may be stationary or mobile. Additionally, each AP 105 and STA 110 can have multiple antennas.

While, the STAs 110 are capable of communicating with each other through the AP 105 using communication links 115, STAs 110 can also communicate directly with each other via direct wireless communication links 120. Direct wireless communication links can occur between STAs 110 regardless of whether any of the STAs is connected to an AP 105. As such, a STA 110 or like device can include techniques for using compressed beamforming information for optimizing MIMO operations as described herein with respect to an AP 105.

The STAs 110 and AP 105 shown in FIG. 1 communicate according to the WLAN radio and baseband protocol including physical (PHY) and medium access control (MAC) layers from IEEE 802.11, and its various versions including, but not limited to, 802.11b, 802.11g, 802.11a, 802.11n, 802.11ac, 802.11ad, 802.11ah, 802.11z, etc. Thus, WLAN 100 implements a contention-based protocol that allows a number of devices (e.g., STAs 110 and APs 105) to share the same wireless medium (e.g., a channel) without pre-coordination. To prevent several devices from transmitting over the channel at substantially the same time each device in a BSS operates according to certain procedures that structure and organize medium access, thereby mitigating interference between the devices.

The AP 105 and/or one or more of the wireless stations 110 may be configured to support SBS communications. Various mechanisms described herein can be implemented by the AP 105 or STAs 110 to facilitate the SBS communications. More specifically, interference can be mitigated by aligning SBS communications to begin at substantially the same time and end at substantially the same time. Additionally or alternatively, during channel contention, a first backoff period for a first channel can be determined and a second different backoff period for a second channel can be determined to ensure proper sensing of the channels and/or allow the second channel to be monitored only for a shorter backoff period. Additionally or alternatively, a channel reservation signal (e.g., CTS2S signal) is then transmitted on the second channel at a start of a first data communication on the first channel to help ensure that access to the second channel is maintained.

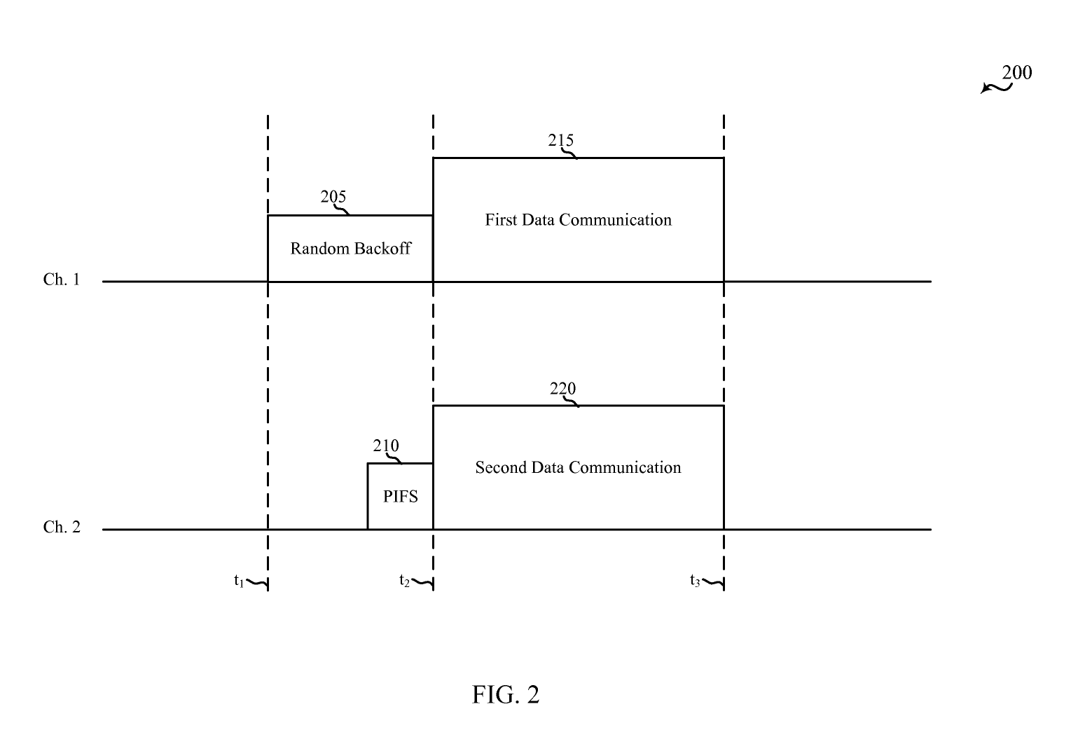

FIG. 2 shows a timing diagram 200 for a device, in accordance with various aspects of the present disclosure. The timing diagram 200 illustrates SBS communications on a first channel Ch. 1 and a second channel Ch. 2. As described above, the device performing the SBS communications is either the AP 105 or one of the wireless stations 110.

As part of contending for the channels, the device determines a random backoff period 205 for the first channel Ch. 1, which begins at time t₁ and ends at a time t₂. During the random backoff period 205, the device monitors the first channel Ch. 1 to make sure the first channel Ch. 1 is free before a first data communication 215 is performed.

The device also determines a second backoff period 210 for the second channel Ch. 2. For example, the second backoff period 210 may be a PIFS or some other period of time that is shorter than the random backoff period 205 set for the first channel Ch. 1. The second backoff period 210 is set to expire at substantially the same time t₂ as the random backoff period 205. During the second backoff period 210, the device monitors the second channel Ch. 2 to make sure the second channel Ch. 2 is free before a second data communication 220 is performed.

If the first channel Ch. 1 is busy or becomes busy during the random backoff period 205, the device defers access to both the first channel Ch. 1 and the second channel Ch. 2 (performing neither the first data communication 215 nor the second data communication 220), and may contend for the channels again at a later time. If the first channel Ch. 1 is free during the random backoff period 205, but the second channel Ch. 2 is busy or becomes busy during the second backoff period 210, the device defers access to both the first channel Ch. 1 and the second channel Ch. 2. Alternatively, the device proceeds with the first data communication 215 on the first channel Ch. 1 while deferring access to the second channel Ch. 2 (by not performing the second data communication 220) when the first channel Ch. 1 is free during the random backoff period 205 and the second channel Ch. 2 is busy or becomes busy during the second backoff period 210. In other words, the device can either wait to attempt the first and second data communications 215, 220 as SBS communications when either channel is busy during the respective backoff period, or proceed with the first data communication 215 only whenever possible (e.g., as a higher priority communication or to take advantage of the available access to the first channel Ch. 1).

If the first channel Ch. 1 is free during the random backoff period 205 and the second channel Ch. 2 is free during the second backoff period 210, the device performs both the first data communication 215 on the first channel Ch. 1 and the second data communication 220 on the second channel Ch. 2 as SBS communications as shown. Because the random backoff period 205 and the second backoff period 210 end at substantially the same time t₂, the first data communication 215 and the second data communication 220 begin at substantially the same time (e.g., at time t₂).

A size (e.g., number of frames) of the first data communication 215 and a size of the second data communication 220 are controlled or otherwise determined to be the same so that the first data communication 215 and the second data communication 220 also end at substantially a same time t₃. For example, once the size of the first data communication 215 is determined, the second data communication 220 is sized accordingly. Thus, the first data communication 215 and the second data communication 220 are aligned to begin at substantially the same time t2 and to end at substantially the same time t3. Such alignment helps to mitigate collocation interference between the first and second data communications 215, 220.

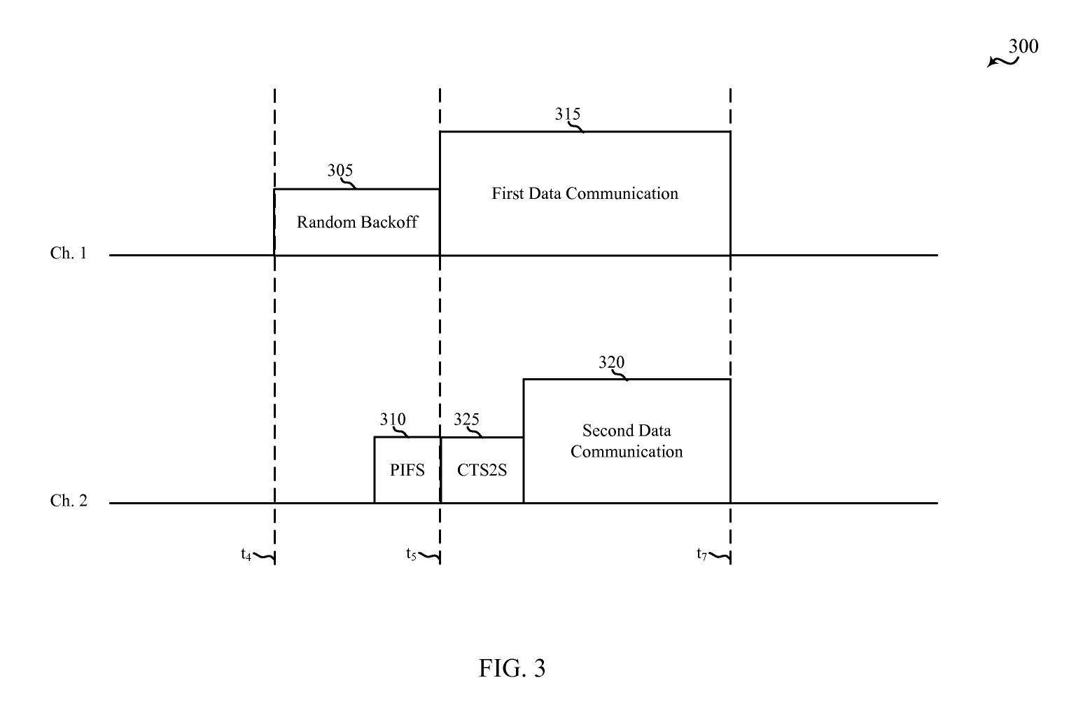

FIG. 3 shows another timing diagram 300 for a device, in accordance with further aspects of the present disclosure. Similar to the timing diagram 200 in FIG. 2, the timing diagram 300 illustrates SBS communications on a first channel Ch. 1 and a second channel Ch. 2. As described above, the device performing the SBS communications is either the AP 105 or one of the wireless stations 110.

As part of contending for the channels, the device determines a random backoff period 305 for the first channel Ch. 1, which begins at time t₁ and ends at a time t₅. The device also determines a second backoff period 310 for the second channel Ch. 2, which can be a PIFS. The second backoff period 310 is set to expire at substantially the same time t₅ as the random backoff period 305. The device monitors the first channel Ch. 1 during the random backoff period 305 and monitors the second channel Ch. 2 during the second backoff period 310. The device determines whether to perform a first data communication 315 or whether to perform both the first data communication 315 and a second data communication 320 such as described above with respect to FIG. 2. Thus, in the case that both the first channel Ch. 1 is free during the random backoff period 305 and the second channel Ch. 2 is free during the second backoff period 310, the device performs both the first data communication 315 on the first channel Ch. 1 and the second data communication 320 on the second channel Ch. 2 as SBS communications as shown in the timing diagram 300.

As shown, the device precedes the second data communication 320 with a channel reservation signal (e.g., a CTS2S signal) 325 on the second channel Ch. 2. The CTS2S signal 325 sets a NAV that reserves the second channel, Ch. 2, to provide time for the device to prepare for performing the second data communication 320. For example, the device may need time to prepare the second data communication 320 (e.g., aggregate frames or other operation(s)). Thus, the CTS2S 325 signal reserves access to the second channel Ch. 2 at time t₅ in case the second data communication is not started at the time t₅ the first data communication 315 is started. In such case, the device determines a size of the second data communication 320 (different from a size as the first data communication 315) such that both the first data communication 315 on the first channel Ch. 1 and the second data communication 220 on the second channel Ch. 2 end at substantially a same time t₇. Such alignment of the ending times helps to mitigate interference between the first and second data communications 315, 320. It should be understood that the NAV can be set to be shorter than a length of the first data communication (e.g., frame) over the first channel.

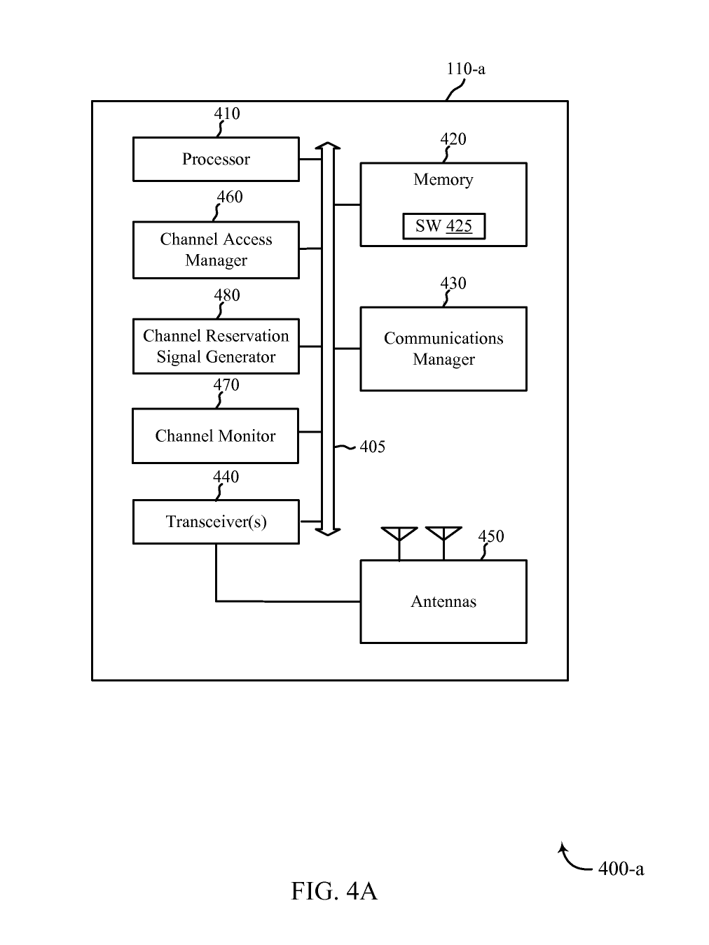

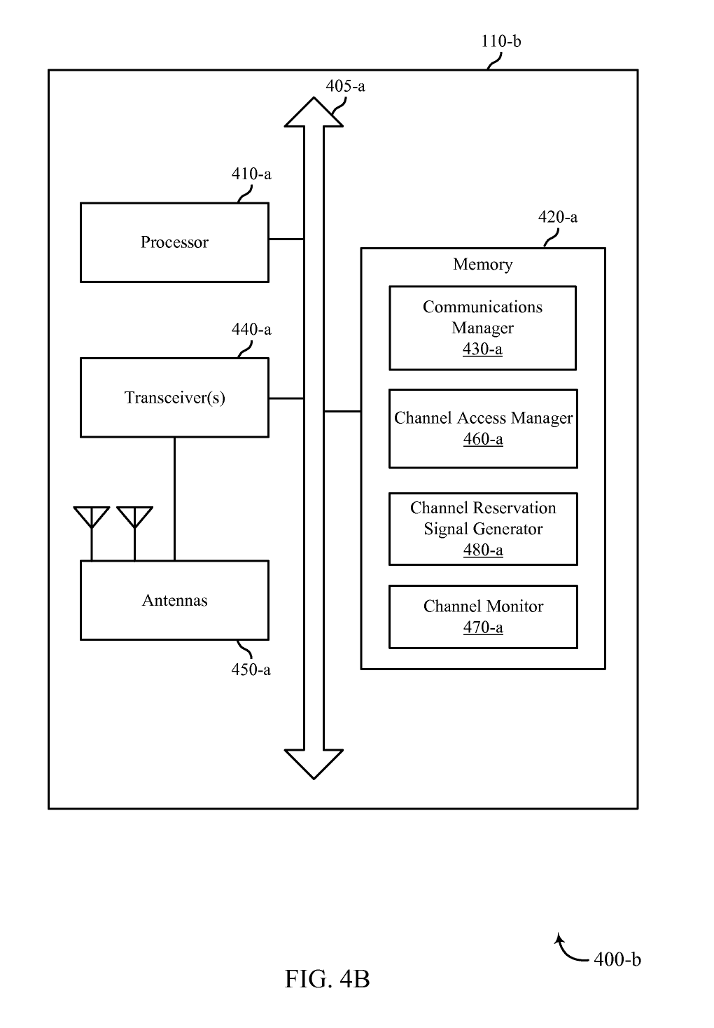

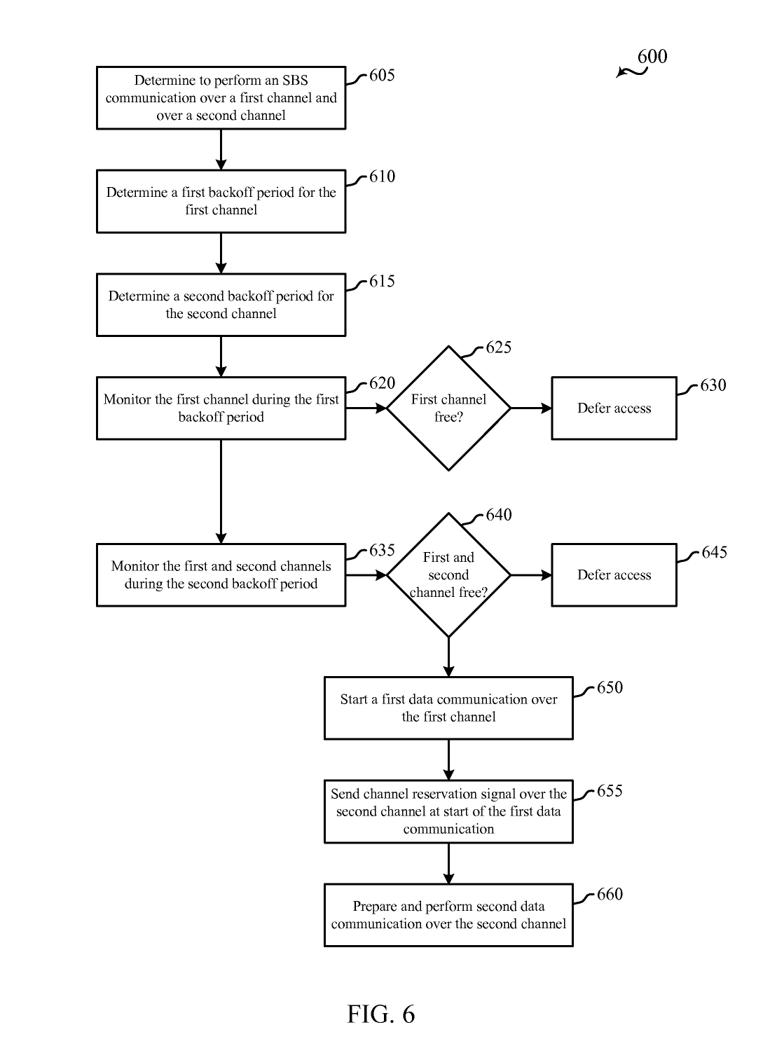

Turning to FIG. 4A, block diagram 400-a is shown that illustrates a wireless station 110-a for use in wireless communication, in accordance with various aspects of the present disclosure. The wireless station 110-a may have various other configurations and may be included or be part of a personal computer (e.g., laptop computer, netbook computer, tablet computer, etc.), a cellular telephone, a PDA, a digital video recorder (DVR), an internet appliance, a gaming console, an e-readers, etc. The wireless station 110-a can have an internal power supply (not shown), such as a small battery, to facilitate mobile operation. The wireless station 110-a is an example of the wireless stations 110 of FIG.1 and may perform SBS communications in accordance with the timing diagrams of FIGS. 2 and/or 3 or in accordance with aspects of the method described with respect to FIG. 6.

As shown, the wireless station 110-a includes a processor 410, a memory 420, one or more transceivers 440, antennas 450, and a communications manager 430. Each of these components are in communication with each other, directly or indirectly, over at least one bus 405.

The memory 420 can include RAM and ROM. The memory 420 stores computer-readable, computer-executable software (SW) code 425 containing instructions that are configured to, when executed, cause the processor 410 to perform various functions described herein for supporting SBS communications. Alternatively, the software code 425 is not directly executable by the processor 410 but is configured to cause a computer (e.g., when compiled and executed) to perform functions described herein.

The processor 410 can include an intelligent hardware device, e.g., a CPU, a microcontroller, an ASIC, etc. The processor 410 processes information received through the transceiver(s) 440 and/or to be sent to the transceiver(s) 440 for transmission through the antennas 450. The processor 410 handles, alone or in connection with the communications manager 430, various aspects for supporting SBS communications.

The transceiver(s) 440 are configured to communicate bi-directionally with APs 105 and/or other STAs 110, such as described with respect to FIG. 1. The transceiver(s) 440 can be implemented as at least one transmitter and at least one separate receiver. The transceiver(s) 440 includes, for example, a modem configured to modulate the packets and provide the modulated packets to the antennas 450 for transmission, and to demodulate packets received from the antennas 450. While the wireless station 110-a can include a single antenna, there are aspects in which the wireless station 110-a includes multiple antennas 450.

The communications manager 430 manages communications with various access points or other stations. The communications manager 430 is a component of the wireless station 110-a in communication with some or all of the other components of the wireless station 110-a over the at least one bus 405. Alternatively, functionality of the communications manager 430 can be implemented as a component of the transceiver(s) 440, as a computer program product, and/or as at least one controller element of the processor 410.

According to the architecture of FIG. 4A, the wireless station 110-a further includes a channel access manager 460, a channel monitor 470 and a channel reservation signal generator 480, each of which can be controlled by or operate in conjunction with the communications manager 430. In some cases, the communications manager 430 includes two different medium access controllers (MACs) (not shown) that operate on different channels. Alternatively, the channel access manager 460 can include the two MACs. The channel access manager 460 performs various operations and/or procedures for channel access contention. For example, the channel access manager 460 determines a random backoff period for a first channel, and determines a second backoff period for a second channel to content for access to the first and second channels for SBS communications. The random backoff period can be determined in any suitable manner, such as known in the art. The second backoff period is be determined based at least in part on the random backoff period, e.g., shorter than the random backoff period and ending at substantially the same time as the random backoff period. In the case of a fixed backoff period (e.g., PIFS) for the second backoff period, the start time of the second backoff period is determined such that the second backoff period ends at substantially the same time as the random backoff period.

The channel monitor 470 monitors the status (e.g., free/idle, busy) of the first channel for the random backoff period and monitors the status of the second channel for the second backoff period, as determined by the channel access manager 460. The channel monitor 470 is controlled by the channel access manager 460 in some implementations.

The channel reservation signal generator 480 also is controlled by or at least operates in conjunction with the channel access manager 460 in some implementations. Based at least in part on a result of monitoring the second channel for the second backoff period, the channel reservation signal generator 480 generates a CTS2S signal with a specific NAV. For example, the NAV is set based at least in part on operations to be performed in preparation for performing the second data communication on the second channel. It should be understood that the channel reservation signal generator 480 generates (e.g., be instructed/controlled to generate) the CTS2S signal only if the second channel is determined to be free during the second backoff period.

Thus, the components of the wireless station 110-a are configured to implement aspects discussed above with respect to FIGS. 2 and 3. Moreover, the components of the wireless station 110-a are configured to implement aspects discussed below with respect to FIG. 6, and those aspects may not be repeated here for the sake of brevity.

FIG. 4B shows a block diagram 400-b that illustrates a wireless station 110-b for use in wireless communication, in accordance with various aspects of the present disclosure. The wireless station 110-b is an example of the wireless stations 110 of FIGS.1 and 4A, and implements various aspects described with reference to FIGS. 2, 3 and 6. As shown, the wireless station 110-b includes a processor 410-a, a memory 420-a, at least one transceiver 440-a, and at least one antenna 450-a. Each of these components are in communication, directly or indirectly, with one another (e.g., over a bus 405-a). Each of these components perform the functions described above with reference to FIG. 4A.

In this example, the memory 420-a includes software that performs the functionality of a communications manager 430-a, a channel access manager 460-a, a channel monitor 470-a and a channel reservation signal generator 480-a. For example, memory 420-a includes software that, when compiled and executed, causes the processor 410-a (or other components of the wireless station 110-b) to perform the functionality described above and further below. A subset of the functionality of the communications manager 430-a, the channel access manager 460-a, the channel monitor 470-a and the channel reservation signal generator 480-a can included in memory 420-a; alternatively, all such functionality can be implemented as software executed by the processor 410-a to cause the wireless station 110-b to perform such functions. Other combinations of hardware/software can be used to perform the functions of the communications manager 430-a, the channel access manager 460-a, the channel monitor 470-a and the channel reservation signal generator 480-a.

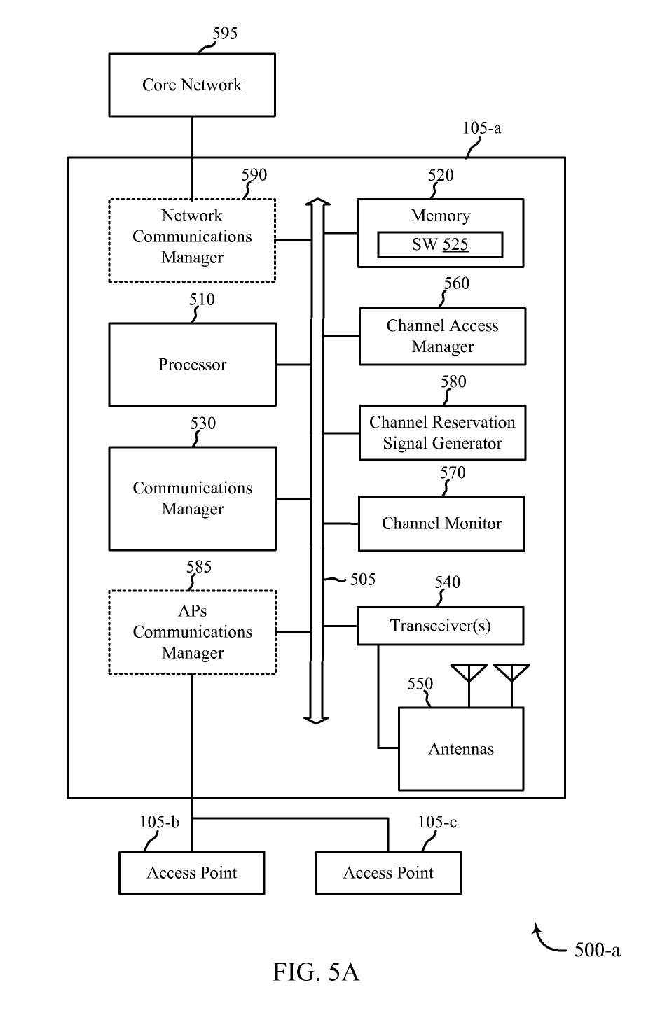

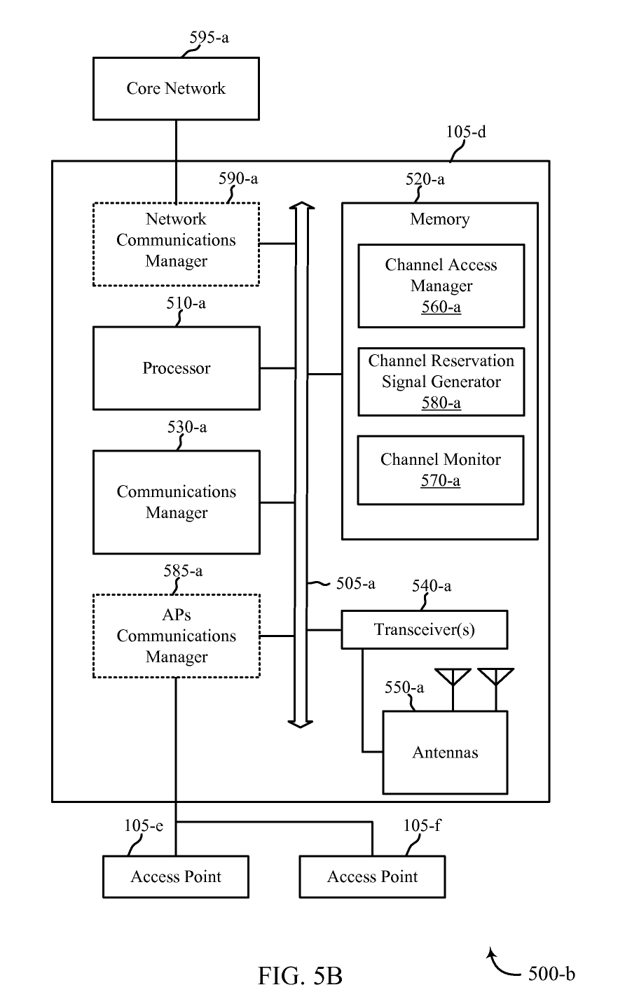

Turning to FIG. 5A, a block diagram 500-a is shown that illustrates an access point or AP 105-a for use in wireless communication, in accordance with various aspects of the present disclosure. In some aspects, the AP 105-a is an example of the AP 105 of FIG. 1. The AP 105-a includes a processor 510, a memory 520, transceiver(s) 540, antennas 550, and a communications manager 530. In some examples, the AP 105-a also includes one or both of an APs communications manager 585 and a network communications manager 590. Each of these modules are in communication with each other, directly or indirectly, over at least one bus 505.

The memory 520 can include random access memory (RAM) and read-only memory (ROM). The memory 520 stores computer-readable, computer-executable software (SW) code 525 containing instructions that are configured to, when executed, cause the processor 510 to perform various functions described herein for supporting SBS communications. Alternatively, the software code 525 is not directly executable by the processor 510 but is configured to cause the computer, e.g., when compiled and executed, to perform functions described herein.

The processor 510 can include an intelligent hardware device, e.g., a central processing unit (CPU), a microcontroller, an ASIC, etc. The processor 510 processes information received through the transceiver(s) 540, the APs communications manager 585, and/or the network communications manager 590. The processor 510 also processes information to be sent to the transceiver(s) 540 for transmission through the antennas 550, to the APs communications manager 585, and/or to the network communications manager 590. The processor 510 handles, alone or in connection with the communications manager 530, various aspects for supporting SBS communications.

The transceiver (s) 540 includes, for example, a modem configured to modulate the packets and provide the modulated packets to the antennas 550 for transmission, and to demodulate packets received from the antennas 550. The transceiver(s) 540 can be implemented as at least one transmitter and at least one separate receiver. The transceiver(s) 540 are configured to communicate bi-directionally, via the antennas 550, with at least one wireless station 110 as illustrated in FIGS. 1, 4A and/or 4B. The AP 105-a typically includes multiple antennas 550 (e.g., an antenna array). The AP 105-a communicates with a core network 595 through the network communications manager 590. The AP 105-a communicates with other APs, such as access point 105-b and access point 105-c, using the APs communications manager 585.

According to the architecture of FIG. 5A, the AP 105-a includes the communications manager 530, which manages communications with various stations. The communications manager 530 is a component of the AP 105-a in communication with some or all of the other components of the AP 105-a over the at least one bus 505. Alternatively, functionality of the communications manager 530 is implemented as a component of the transceiver(s) 540, as a computer program product, and/or as at least one controller element of the processor 510.

According to the architecture of FIG. 5A, the AP 105-a further includes a channel access manager 560, a channel monitor 570 and a channel reservation signal generator 580, each of which can be controlled by or operate in conjunction with the communications manager 530. In some cases, the communications manager 530 includes two different medium access controllers (MACs) (not shown) that operate on different channels. Alternatively, the channel access manager 560 can include the two MACs. The channel access manager 560, the channel monitor 570 and the channel reservation signal generator 580 perform various operations and/or procedures as described above with respect to FIG. 4A. Thus, the components of the AP 105-a is configured to implement aspects discussed above with respect to FIGS. 2 and 3. Moreover, the components of the AP 105-a is configured to implement aspects discussed below with respect to FIG. 6, and those aspects may not be repeated here for the sake of brevity.

FIG. 5B shows a block diagram 500-b that illustrates an AP 105-d for use in wireless communication, in accordance with various aspects of the present disclosure. The AP 105-d is an example of the AP 105, 105-a of FIGS.1 and 5A, and may implement various aspects described with reference to FIGS. 2, 3 and 6. The AP 105-d includes a processor 510-a, a memory 520-a, at least one transceiver 540-a, at least one antenna 550-a, a communications manager 530-a, an APs communications manager 585-a (for communicating with APs 105-e and 105-f) and a network communications manager 590-a (for communicating with a core network 595-a). Each of these components of the AP 105-d are in communication, directly or indirectly, with one another (e.g., over a bus 505-a). Each of these components perform the functions described above with reference to FIG. 5A.

In this example, the memory 520-a includes software that performs the functionality of a channel access manager 560-a, a channel monitor 570-a and a channel reservation signal generator 580-a. For example, memory 520-a includes software that, when compiled and executed, causes the processor 510-a (or other components of the AP 105-d) to perform the functionality described above and further below. A subset of the functionality of the channel access manager 560-a, the channel monitor 570-a and the channel reservation signal generator 580-a can be included in memory 520-a; alternatively, all such functionality is implemented as software executed by the processor 510-a to cause the AP 105-d to perform such functions. Other combinations of hardware/software can be used to perform the functions of the channel access manager 560-a, the channel monitor 570-a and the channel reservation signal generator 580-a.

FIG. 6 is a flow chart illustrating an example of a method 600 for wireless communication, in accordance with various aspects of the present disclosure. The method 600 may be performed by any of the STAs 110 or APs 105 discussed in the present disclosure, but for clarity the method 600 will be described from the perspective of the AP 105-a of FIG. 5A. Broadly speaking, the method 600 illustrates a procedure by which the AP 105-a performs a first contention-based access procedure for a first channel, performs a second contention-based access procedure for a second channel based at least in part on the first contention-based access procedure, transmits a first data communication on the first channel based at least in part on the first contention-based access procedure, and transmits a CTS2S signal on the second channel at the beginning of the first data communication on the first channel to reserve the second channel while framing the data for transmission over the second channel.

At block 605, the communications manager 530, transceiver 540, and antenna(s) 550 determine that an SBS communication is to be performed over a first channel and over a second channel. Any suitable technique can be used for determining whether an SBS communication is to be performed. For example, various factors such as existing channel congestion, number of communications pending at the AP 105-a, whether simultaneous communications are beneficial or needed (e.g., in the case of a STA 110 performing the method 600, the STA may communicate with two different basic service sets (BSSs) that are on different channels in the same band to maintain a first link to a display and a second link to an AP for a video game server), etc.

Once an SBS communication is to be performed, the channel access manager 560 of the AP 105-a contends for access to the first and second channels. As part of the access contention process, the channel access manager 560 determines a first backoff period for the first channel at block 610. The first backoff period can be determined as a random backoff period, such as known in the art.

Once the first backoff period for the first channel has been determined, the channel access manager 560 determines a second backoff period for the second channel at block 615. The second backoff period is shorter in duration than the first backoff period and ends at a substantially the same time as the first backoff period. In some implementations, the second backoff period is a fixed period, such as a PIFS. In this case, the start of the second backoff period is determined such that the second backoff period ends at substantially the same time as the first backoff period.

At block 620, the channel monitor 570 of the AP 105-a monitors the first channel during a first portion of the first backoff period, prior to the start of the second backoff period. If the first channel is busy at any point during the first portion of the first backoff period, the channel access manager 560 determines at block 625 that the first channel is not free. Then, at block 630, the channel access manager 560 defers access to the first channel, and can re-contend for the first channel at a later time. In some cases, the method returns from block 630 to block 605 to determine if an SBS communication still is to be performed.

On the other hand, if channel access manager 560 determines at block 625 that the first channel is free during the first portion of the first backoff period, the method 600 jumps to block 635 where the channel monitor 570 of the AP 105-a monitors the first channel and the second channel during a remainder of the first backoff period/the second backoff period. Because the second backoff period begins after the first portion of the first backoff period, it is possible that the first channel is determined to be busy before monitoring of the second channel begins, as described with reference to blocks 625 and 630. However, as long as the first channel is free during the first portion of the first backoff period, at least some monitoring of the second channel is performed (e.g., during the second backoff period).

If either the first channel is busy at any point during the remainder of the first backoff period or the second channel is busy at any point during the second backoff period, the channel access manager 560 determines that the first and second channels are not free. Then, at block 645, the channel access manager 560 defers access to both the first and second channels, and can re-contend for the channels at a later time. In some cases, the method 600 returns from block 645 to block 605 to determine if an SBS communication still is to be performed.

Alternatively (not shown), in case the channel access manager 560 determines that the first channel is free but the second channel is not free, the AP 105-a defers access to only the second channel at block 645, and proceeds with a first data communication over the first channel (although not as an SBS communication with a second data communication not being performed over the second channel). Again, the method 600 can return from block 645 to block 605, in this case to determine if a different SBS communication is to be performed (e.g., the second data communication and a third data communication).

On the other hand, if the first channel is free during the entire remainder of the first backoff period and the second channel is free during the entire second backoff period, the channel access manager 560 determines at block 640 that the first and second channels are free. Thus, if the first channel is free during the entire first backoff period and the second channel is free during the entire second backoff period, the method 600 continues to block 650.

At block 650, the communications manager 530, in conjunction with the transceiver(s) 540 and antennas(s) 550, starts a first data communication over the first channel. Then, the method continues to block 655, where the communications manager 530 and the channel reservation signal generator 580 in conjunction with the transceiver 540 and antenna(s) 550 transmit a channel reservation signal (e.g., a CTS2S or vendor-specific signal) over the second channel at the start of the first data communication.

The method 600 then continues to block 660, where the communications manager 530 prepares and performs the second data communication over the second channel simultaneously with the first data communication over the first channel. In a case where no preparation is needed for the second data communication, it should be understood that operation(s) at block 655 are skipped, and the method continues from block 650 to block 660 to perform the second data communication over the second channel simultaneously with the first data communication over the first channel.

Thus, the method 600 provides support for SBS communications. It should be noted that the method 600 is just one implementation and that the operations of the method 600 can be rearranged or otherwise modified such that other implementations are possible.

The detailed description set forth above in connection with the appended drawings describes examples and does not represent the only examples that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A method for wireless communication, comprising:
performing a first contention-based access procedure for a first channel;
performing a second contention-based access procedure for a second channel based at least in part on the first contention-based access procedure performed for the first channel;
transmitting a first data communication on the first channel based at least in part on the first contention-based access procedure performed for the first channel; and
transmitting a channel reservation signal on the second channel at a beginning of the first data communication on the first channel based at least in part on the second contention-based access procedure performed for the second channel.

2. The method of claim 1, wherein the channel reservation signal establishes a network allocation vector (NAV) for the second channel.

3. The method of claim 2, wherein the channel reservation signal comprises a clear-to-send-to-self (CTS2S) signal.

4. The method of claim 1, further comprising:
transmitting a second data communication on the second channel during the transmission of the first data communication on the first channel.

5. The method of claim 4, wherein transmitting the second data communication comprises ending the second data communication at a substantially the same time as the first data communication ends.

6. The method of claim 4, wherein transmitting the first data communication and transmitting the second data communication comprise a single band simultaneous (SBS) operation using the first and second channels.

7. The method of claim 1, wherein:
performing the second contention-based access procedure includes monitoring the second channel for a backoff period prior to transmitting the first data communication on the first channel; and
transmitting the channel reservation signal on the second channel is performed only if the second channel is clear during the backoff period.

8. The method of claim 7, further comprising:
determining the backoff period for the second channel based at least in part on a different backoff period for the first channel.

9. The method of claim 8, wherein transmitting the first data communication on the first channel and transmitting the channel reservation signal on the second channel are performed only if both the first channel is clear during the different backoff period for the first channel and the second channel is clear during the backoff period for the second channel.

10. The method of claim 8, wherein the backoff period for the second channel is determined to be shorter than the different backoff period for the first channel and to end at substantially a same time as the different backoff period.

11. The method of claim 10, wherein:
performing the first contention-based access procedure includes monitoring the first channel for the different backoff period; and
monitoring the second channel is performed only for the backoff period.

12. An apparatus for wireless communication, comprising:
a channel monitor to monitor a first channel as part of a first contention-based access procedure and to monitor a second channel as part of a second contention-based access procedure, the second contention-based access procedure based at least in part on the first contention-based access procedure;
a transmitter to transmit a first data communication on the first channel based at least in part on a result of monitoring the first channel and to transmit a channel reservation signal on the second channel at a beginning of the first data communication on the first channel based at least in part on a result of monitoring the second channel.

13. The apparatus of claim 12, further comprising:
a channel reservation signal generator to generate the channel reservation signal, the generated channel reservation signal establishing a network allocation vector (NAV) for the second channel.

14. The apparatus of claim 13, wherein the generated channel reservation signal establishes the NAV to be shorter in duration than a length of a frame for the first data communication on the first channel.

15. The apparatus of claim 12, wherein the transmitter is further to transmit a second data communication on the second channel during the transmission of the first data communication on the first channel.

16. The apparatus of claim 12, wherein:
the channel monitor is to monitor the second channel for a backoff period prior to transmission of the first data communication on the first channel; and
the transmitter is to transmit the channel reservation signal on the second channel only if the second channel is clear during the backoff period.

17. The apparatus of claim 16, further comprising:
a channel access manager to determine the backoff period for the second channel based at least in part on a different backoff period for the first channel.

18. The apparatus of claim 17, wherein the transmitter is to transmit the first data communication on the first channel and transmit the channel reservation signal on the second channel only if both the first channel is clear during the different backoff period for the first channel and the second channel is clear during the backoff period for the second channel.

19. The apparatus of claim 17, wherein channel access manager is to determine the backoff period for the second channel to be shorter than the different backoff period for the first channel and to end at substantially a same time as the different backoff period.

20. The apparatus of claim 19, wherein the channel monitor is to monitor the first channel for the different backoff period and to monitor the second channel only for the backoff period.

21. An apparatus for wireless communication, comprising:
means for performing a first contention-based access procedure for a first channel;
means for performing a second contention-based access procedure for a second channel based at least in part on the first contention-based access procedure performed for the first channel;
means for transmitting a first data communication on the first channel based at least in part on the first contention-based access procedure performed for the first channel; and
means for transmitting a channel reservation signal on the second channel at a beginning of the first data communication on the first channel based at least in part on the second contention-based access procedure performed for the second channel.

22. The apparatus of claim 21, further comprising means for generating the channel reservation signal, the generated channel reservation signal establishing a network allocation vector (NAV) for the second channel.

23. The apparatus of claim 21, wherein the means for performing the second contention-based access procedure monitors the second channel for a backoff period prior to transmitting the first data communication on the first channel; and
the means for transmitting the channel reservation signal on the second channel transmits the channel reservation signal only if the second channel is clear during the backoff period.

24. The apparatus of claim 23, further comprising:
means for determining the backoff period for the second channel based at least in part on a different backoff period for the first channel.

25. The apparatus of claim 24, wherein the means for transmitting the first data communication on the first channel transmits the first data communication and the means for transmitting the channel reservation signal on the second channel transmits the channel reservation signal only if both the first channel is clear during the different backoff period for the first channel and the second channel is clear during the backoff period for the second channel.

26. The apparatus of claim 24, wherein the means for determining the backoff period for the second channel determines the backoff period to be shorter than the different backoff period for the first channel and to end at substantially a same time as the different backoff period.

27. The apparatus of claim 26, wherein:
the means for performing the first contention-based access procedure monitors the first channel for the different backoff period; and
the means for performing the second contention-based access procedure monitors the second channel for only the backoff period.

28. A non-transitory computer-readable medium comprising computer-readable code that, when executed, causes a device to:
perform a first contention-based access procedure for a first channel;
perform a second contention-based access procedure for a second channel based at least in part on the first contention-based access procedure performed for the first channel;
transmit a first data communication on the first channel based at least in part on the first contention-based access procedure performed for the first channel; and
transmit a channel reservation signal on the second channel at a beginning of the first data communication on the first channel based at least in part on the second contention-based access procedure performed for the second channel.

29. The non-transitory computer-readable medium of claim 28, wherein the channel reservation signal establishes a network allocation vector (NAV) for the second channel.

30. The non-transitory computer-readable medium of claim 29, wherein the channel reservation signal comprises a clear-to-send-to-self (CTS2S) signal.
